(19) United States
(12) Patent Application Publication
(10) Pub. No.: US 2001/0017818 A1
(43) Pub. Date: Aug. 30, 2001

(54) Time interval measuring instrument

(76) Inventor: Werner Wittauer, Weidenberg (DE)

Correspondence Address: David Toren, BROWN & WOOD LLP, One World Trade Center, New York, NY, 10048-0557, US

(21) Appl. No.: 09/769,697

(22) Filed: Jan. 25, 2001

(30) Foreign Application Priority Data
Jan. 25, 2000 (DE) 200 01 182.0

(51) Int. Cl. G04C 17/00; G04B 19/00; G04B 25/00

(52) U.S. Cl. 368/223

(57) ABSTRACT

Time interval measuring instrument including supported on a base, a transparent guide and two marking strips arranged on opposite longitudinal sides of the guide and provided with marking lines and figures, with the indicator parts being piled up on the bottom upon being introduced through the top guide opening.

### BACKGROUND OF THE INVENTION

1. Field of the Invention

The present invention relates to a time interval measuring instrument including elongate marking means defining a row of time intervals limited by marking lines, with a row of figures associated with the time intervals, respectively, and having increasing numerical values, with a lowest numerical value being at a bottom and a highest numerical value being at a top, elongate receiving means extending parallel to the marking means for receiving indicator parts which form a row in the receiving means, with a desired quantity of the indicator parts being added or removed, and a base for supporting both the marking and receiving means.

2. Description of the Prior Art

German Utility Model DE 8814723 UI discloses a time interval measuring instrument in which the receiving means is formed as a stepped board supported on a base, with the step flight forming the marking means and with the steps defining the time intervals and the boundary edges defining the marking lines. The stepped board has a pin for each step or each interval provided with an article. The time interval measuring instrument of DE 8814723UI serves as an advent calendar with which at the beginning of the measurement, all of the pins are provided with event articles, respectively. Each day, a row according to the event article is lifted and is set higher on a figure of a step standing on the board. The lifted articles are piled in a predetermined quantity. The known time interval measuring instrument because of the stepped board, is rather volumous and because of this, the increase of a number of intervals over the interval period of the advent season is not possible.

German Patent No. 57,004 discloses a time interval measuring instrument in which there is provided elongate marking means with a row of intervals limited by marking lines and a row of figures associated with the intervals and having different numerical values, and elongate receiving means extending parallel to the marking means. A plurality of indicator parts is associated with the receiving means. The indicator parts form a row in the receiving means, with a desired quantity of the indicator parts being added and removed. Both the marking and indicator means are supported on a common base. In this time interval measuring instrument, the marking means forms a marking region provided with marking lines and figures, and the receiving means forms a guide having an upper opening for introducing the indicator parts which pile up on a support bottom. The indicator parts are formed as standard parts introduced through the upper opening of the guide and sliding toward the support bottom. The parts form a stack in the guide, with the lower end of the stack being associated with the marking region.

Accordingly, on object of the present invention is to provide a time interval measuring instrument of the type described above which would have a compact structure, an increased number of intervals, and an increased number of the indicator parts.

### SUMMARY OF THE INVENTION

This and other objects of the present invention, which will become apparent hereinafter, are achieved by providing a time interval measuring instrument in which:

(i) the marking means is formed as flat marking strip means provided with marking lines and figures and arranged sidewise of and adjacent to the receiving means as a functionally separate part,

(ii) the receiving means is formed as a transparent guide having a bottom on which the indicator parts are piled up and which lies on the base, and having an opening provided at a top of the guide for putting the indicator parts in,

(iii) the indicator parts are formed as standard parts which are put into the guide through the top opening and slide freely along the guide in a direction toward the guide bottom and which form a stack an upper end of which is associated with respective marking lines of the marking strip means.

A single standard part is introduced into the guide per time unit and slides along the guide until it reaches the guide bottom or the top end of the stack. The standard parts are introduced one after another and form a pilling-up stack the front or “growing” end the position of which can be clearly seen with respect to marking lines of the already expired time period. In distinction from a stair flight, the marking strips are flat. The standard parts are formed as chips or play pieces, and their outer dimensions are so selected that they correspond to the cross-section of the guide, and the standard parts can slide along the glide, forming a stack. This stack, as the mercury column of a conventional thermomether, forms a scale, with the row of marking lines and figures being associated with the growing end of the stack. The standard parts can be very small and can tightly abut one another. All this provides for compactness of the structure of the time interval measuring instrument, provides for increased number of intervals and increased number of standard parts (indicators).

The time interval measuring instrument according to the present invention has, in distinction from the known instrument disclosed in German Patent No. 57,004, the smallest figure value at the bottom and the highest figure value at the top. The inventive time interval measuring instrument further differs from the known instrument in that its marking means is formed as a marking strip(s) which is (are) arranged sidewise of the guide, as a part functionally distinct from the guide. Further, in the inventive time interval measuring tool, it is the upper or front end of the stack or the top standard part is associated with the corresponding marking lines. The guide is completely transparent. Because the marking strip is formed as a functionally separate element from the guide, the inventive time interval measuring instrument is more suitable for time measurements. Forming the marking means as marking strips permits to use larger figures, and other data or information signs can be provided on the strips. A time interval measuring instrument according to the present invention can be used as an advent calendar, abortion calendar, or as a calendar for breaking the smoking habit. The inventive time interval measuring instrument can also be used as a calendar for determining the periods of community service or military service. In all of the cases of use, it is beneficial that marking strips provide space for additional information.

It is possible to use arcuate marking strips and guide and/or to arrange them substantially horizontally. However, it is particularly advantageous when the marking strips and the guide are linear and extend in a direction of action of the gravity force. With this embodiment, the standard parts are easily introduced into the guide and slide along the guide under their own weight.

It is particularly preferable and advantageous when all of the standard parts have, in a direction transverse to a longitudinal extend of the guide, the same circumferential dimension. In this case, the growing stack has the same diameter or circumferential surface over its entire length.

It is also possible to form the guide as a rod on which the standard parts, which have an opening, are piled up. However, it is particularly preferable and advantageous when the guide is formed as a cage-like tubular member for receiving the circular standard parts.

It is particularly preferable and advantageous when the cage-like tubular member is formed as a pipe piece. The pipe can be easily produced especially of a transparent plastic material.

It is possible to provide a marking strip with marking liens and printed figures only on one side of the guide. However, it is particularly preferable and advantageous when a marking strip with marking lines and printed figures is provided on each side of the guide. In this case, the figure can be made larger so that the numbers are more easily distinguishable. It is possible to so closely arranged the marking lines to each other and to make the standard parts with such a thickness that a single standard part is provided for a single interval. However, it is preferable and advantageous when the width of the interval, measured in a direction of the longitudinal extent of the guide corresponds to the thickness of several standard parts piled up in the guide. In this case, the marking lines are clearly visible and distinguishable as they are space from each other by a large distance. Then, for each fraction of an interval, e.g., a day of a month, a single standard part having a very small thickness can be used. One can clearly seen the grow of the column of the standard parts and can regularly determine or measure passing of time within an interval.

When the intervals, which are set in the direction of the longitudinal extent of the guide, have the same width and are associated with different month, and a single standard part is assigned to each day of a month, then due to the difference of the number of days in different months, for each interval, the guide is filled with standard parts having different thicknesses. Therefore, it is preferable and advantageous to provide sets of standard parts having different thicknesses. Thus, e.g., the thickness of a standard part of a 31-piece set will be smaller than a thickness of a standard part of a 28-piece set.

As a rule, the standard parts would have a smooth surface, and the standard parts are supplied as spare parts. However, it is preferable and advantageous when the standard parts are coins. Then, coins of the same value, e.g., 5 German marks, can be used as the standard parts and be introduced into the guide one after another for each day. Then, the passing of time can be judged by correspondence between the top of a column or stack and the marking lines.

Below, specific particularities of the inventive time interval measuring instrument are outlined.

According to the present invention, the guide opening forms continuation of the guide and has a cross-section providing for passing of the standard parts therethrough, with the standard parts being formed as chips or play pieces, with a cross-section of the guide corresponding to a cross-section of the standard parts, and with the guide being formed as a rigid member.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 shows a side view of a time interval measuring instrument according to the present invention; and

FIG. 2 a cross-sectional view of a portion of the time interval measuring instrument shown in FIG. 1 at an increased, in comparison with FIG. 1, scale.

### DETAILED DESCRIPTION OF THE PREFERRED EMBODIMENT

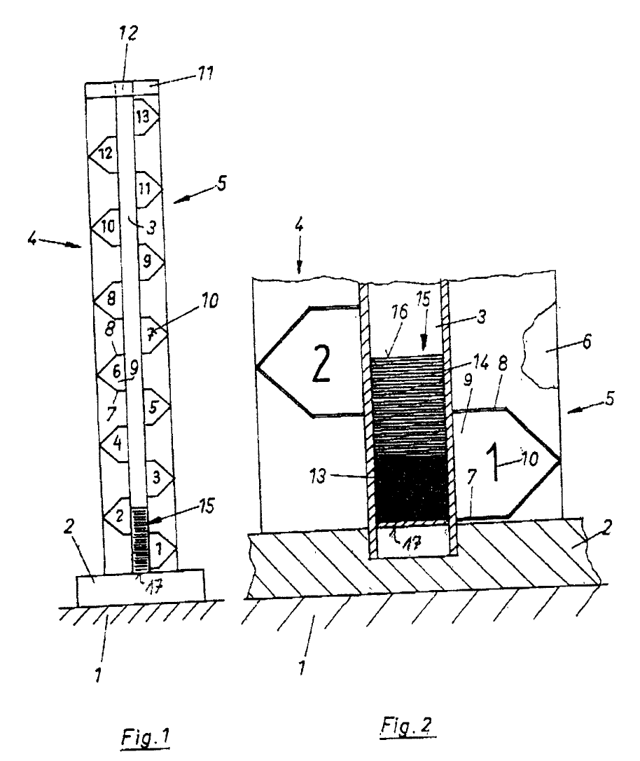

A time interval measuring instrument according to the present invention, which is shown in FIG. 1, includes a base 2 which is formed as a block or a thick plate and is supported on a support 1. A guide 3, which is formed as a tube, is supported on the base 2, extending upward perpendicular to the base 2. The guide 3 is formed of a transparent plastic material. On opposite longitudinal sides of the tubular guide 3, there are provided marking strips 4 and 5, respectively. The marking strips 4 and 5, like the guide 3, extend upward and are mounted on a rigid support 6 supported on the base 2. Each of the strips 4 and 5 is provided with marking lines 7 and 8, with two adjacent marking lines 7 and 8 limiting an interval 9. A specific FIG. 10 is associated with each interval 9. The figures are alternatively provided on the two marking strips 4 and 5. The guide 3 and the strips 4 and 5 are held together at their upper ends with a cap 11 having an opening 12 communicating with inside of the guide 3 and arranged coaxially with the guide 3. There are further provided standard parts 13, 14 which are formed as chips or thin plates. The standard parts 13 and 14 have the same outer dimensions, however, with one parts 13 being somewhat thinner than the other parts 14. The standard parts 13 and 14 form a stack 15 inside the tubular guide 3. The upper end 10 of the stack 15 define a time point originated at a bottom 17. Possible different sets, with standard parts corresponding to respective time intervals for their distinction, are provided with corresponding identification marks. Further, inside the sets, different information can be provided to the user, with the standard parts of a set, e.g., being consecutively numbered in accordance with the ongoing days of a month. The marking strips 4, 5 insure stability and compactness of the instrument. The tubular guide 3 is tightly held between the two strips 4 and 5, with the strips 4, 5 being clamped between the base 2 and the cap 11.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. Time interval measuring instrument, comprising:
elongate marking means defining a row of time intervals limited by marking lines, with a row of figures associated with the time intervals, respectively, and having increasing numerical values, with a lowest numerical value being at a bottom and a highest numerical value being at a top;
elongate receiving means extending parallel to the marking means for receiving indicator parts which form a row in the receiving means, with a desired quantity of the indicator parts being added or removed; and
a base for supporting the marking and receiving means,
wherein the marking means comprises flat marking strip means provided with marking lines and figures and arranged sidewise of and adjacent to the receiving means as a functionally separate part thereof,
wherein the receiving means comprises a transparent guide having a bottom on which the indicator parts are piled up and which lies on the base, and an opening provided at a top of the guide for putting the indicator parts in,
wherein the indicator parts are formed as standard parts which are put into the guide through the top opening and slide freely along the guide in a direction toward the guide bottom and which form a stock an upper end of which is associated with the marking strip means.

2. A time interval measuring instrument as set forth in claim 1, wherein both the marking strip means and the guide extend linearly.

3. A time interval measuring instrument as set forth in claim 1, wherein both the marking strip means and the guide extend perpendicular in a direction of a gravity force.

4. A time interval measuring instrument as set forth in claim 1, wherein all of the standard parts have, transverse to the guide, a same circumferential dimension.

5. A time interval measuring device as set forth in claim 1, wherein the guide has a cage-like shape.

6. A time interval measuring instrument as set forth in claim 1, wherein the cage-like guide is formed as a tube.

7. A time interval measuring instrument as set forth in claim 1, wherein the marking strip means comprises two marking strips provided with marking lines and figures and arranged on opposite longitudinal sides of the guide, respectively.

8. A time interval measuring instrument as set forth in claim 1, wherein a width of a time interval in a longitudinal direction of the guide in several times exceeds a thickness of a standard part in the guide longitudinal.

9. A time interval measuring instrument as set forth in claim 8, wherein sets of standard parts having different thicknesses are provided.

10. A time interval measuring instrument as set forth in claim 1, wherein the standard parts are formed as coins.

11. A time interval measuring instrument as set forth in claim 1, wherein the guide opening forms continuation of the guide and has a cross-section providing for passing of the standard parts.

12. A time interval measuring instrument as set forth in claim 1, wherein the standard parts are formed as chips or play pieces.

13. A time interval measuring instrument as set forth in claim 1, wherein a cross-section of the guide corresponds to a cross-section of the standard parts, and wherein the guide is formed as a rigid member.
